(19) United States
(12) Patent Application Publication
(10) Pub. No.: US 2012/0229660 A1
(43) Pub. Date: Sep. 13, 2012

(54) METHODS AND APPARATUS FOR REMOTE CONTROLLED DEVICES

(76) Inventors: CYNTHIA C. MATTHEWS, Phoenix, AZ (US); William F. Matthews, IV, Phoenix, AZ (US)

(21) Appl. No.: 13/416,944

(22) Filed: Mar. 9, 2012

Related U.S. Application Data
(60) Provisional application No. 61/450,953, filed on Mar. 9, 2011.

(51) Int. Cl. H04N 5/232

(52) U.S. Cl. 348/207.11; 348/E05.042

(57) ABSTRACT

Methods and apparatus for operating a remote controlled device according to various aspects of the present invention may comprise inputting a command into a controller, transmitting the command to the server and relaying the command to the remote controlled device.

### CROSS-REFERENCES TO RELATED APPLICATIONS

This application claims the benefit of U.S. Provisional Patent Application No. 61/450,953, filed Mar. 9, 2011, and incorporates the disclosure of such application by reference.

### BACKGROUND OF THE INVENTION

With the increased, availability of wireless data bandwidth and Internet content, consumers are becoming increasingly reliant and demanding on the functions that can be performed on controllers. Whereas applications or Apps that could be downloaded on controllers were scarce ten years ago, Apps are now widely available across numerous technology platforms. Smart phones, smart tablets, computers and Internet television are becoming an important part of our daily lives in providing easy access to communications, information and entertainment.

Remote controlled (“RC”) devices provide a source of entertainment for the wireless world. RC devices have traditionally been controlled by a person using an RC radio within sight of the device. These typical systems are commonly found on line-of sight-systems. Typical ranges for these AM, FM and spread spectrum RC radios have been from a few feet to several hundred feet. Minimal performance RC devices are extremely popular as children's toys due to their low price and ease of operation. Higher performance devices are less popular due to the increase in price, the technical skills required to maintain the device, and the space requirements needed for operation.

For example, referring to FIG. 1A, a conventional line-of sight system 100 comprising a user 110 operating a RC controller 120 that controls a RC device 130 is depicted. In this conventional RC system, the user 110 may provide various commands to RC controller 24. The RC controller 120 may transmit the commands to the RC device 26. The RC device 130 may receive the commands from the RC controller 120 and performs according to the commands from the RC controller 24. Generally, the RC device 130 must be located within the line-of-sight of the user 110 and the RC controller 24.

### SUMMARY OF THE INVENTION

Methods and apparatus for operating a remote controlled device according to various aspects of the present invention may comprise inputting a command into a controller, transmitting the command to the server and relaying the command to the remote controlled device.

### BRIEF DESCRIPTION OF THE DRAWING FIGURES

A more complete understanding of the present invention may be derived by referring to the detailed description and claims when considered in connection with the following illustrative figures. In the following figures, like reference numbers refer to similar elements and steps throughout the figures.

FIG. 1A illustrates a conventional line-of-sight system showing the operation of a RC device;

FIG. 1B illustrates a user operating an RC device in accordance with various embodiments;

FIG. 2 illustrates a block diagram of the RC device;

FIG. 3 illustrates a block diagram of the controller application;

FIG. 4A illustrates a perspective view of the controller display generated by application during user login

FIG. 4B illustrates a perspective view of the controller display generated by application during the environment and RC device selection process;

FIG. 5A illustrates a perspective view of the controller display generated by application during RC device operation;

FIG. 5B illustrates an alternative perspective view of the controller display generated by application during RC device operation;

FIG. 6 illustrates a block diagram of an environment illustrating the single user using the invention to remotely operate the RC device;

FIG. 7 illustrates a block diagram of multiple users accessing multiple environments;

FIG. 8 illustrates a block diagram of an environment;

FIG. 9 illustrates a block diagram of the gateway server;

FIG. 10 illustrates a block diagram of the device server;

FIG. 11 illustrates a flow chart of the registration and RC device selection process;

FIG. 12 illustrates a flow chart of the RC device operation process; and

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various systems, technologies, algorithms, designs, and the like, which may carry out a variety of functions. In addition, the present invention may be practiced in conjunction with any number of devices, components, or software applications, and the system described is merely one exemplary application for the invention. The present invention may also involve multiple devices, components, programs, functions, or servers. Further, the present invention may employ any number of conventional techniques for selecting, operating, and viewing remote control devices, and the like.

Methods and apparatus for remote control devices according to various aspects of the present invention may operate in conjunction with any suitable control, display, communication, and/or computing process. Various representative implementations of the present invention may be applied to any system for selecting, operating, and viewing remote control devices. Certain representative implementations may include, for example, controlling a remote control device over the Internet.

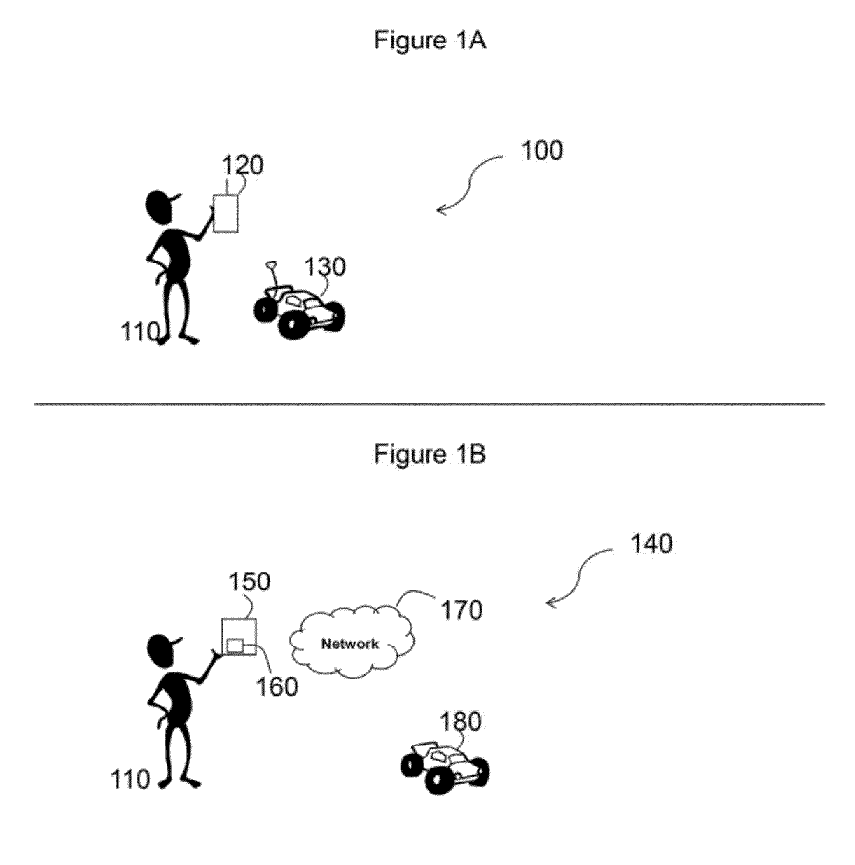

The conventional RC system, a conventional line-of-sight system 100 shown in FIG. 1A, may be modified to incorporate new wireless technologies. For example, referring to FIG. 1B, a line-of-sight environment 140 may operate using a RC network 170 instead of a typical radio system. In various embodiments, a controller 150 and a RC device 180 may both be configured to connect to a RC network 170. In various embodiments, the controller 150 may be configured to run an application 160 to send commands to the RC device 180. The application 160 may be configured to cause the controller 150 to connect to the RC device 180 via the RC network 170. The RC device 180 may be configured to operate according to commands entered by the user into the controller 150 via the application 160 and received via the RC network 170. The RC device 180 may also send communications over the RC network 170 back to the controller 150 or another device,

### The RC Network

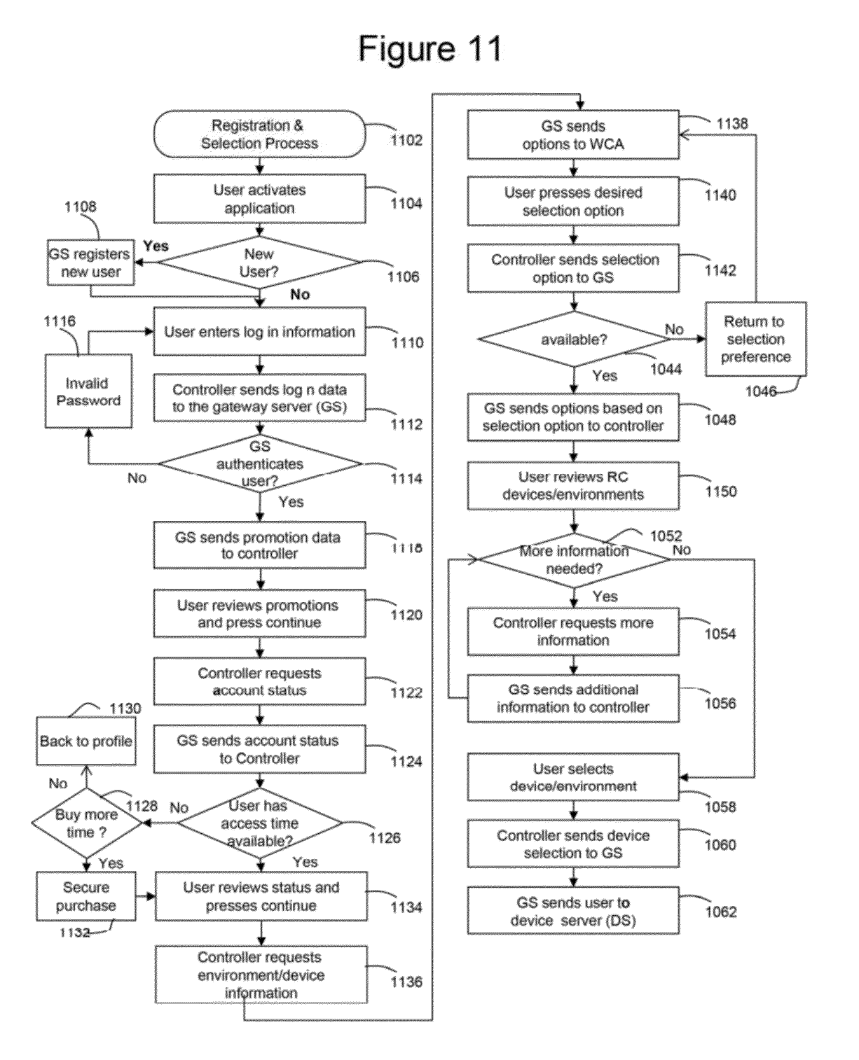

With reference again to FIG. 11, the RC network 170 may comprise any suitable network for connecting the controller 150 to the RC device 180. For example, the RC network 170 may comprise a WIFI network, the Internet, a Bluetooth connection, RF, cellular network, or a low power wireless network designed for short range communication of encoded data.

### The RC Device

The RC device 180 may comprise any remote controlled device. For example, according to various embodiments, the RC device 180 may comprise a RC car, RC truck, RC boat, RC airplane, RC helicopter, or RC hovercraft. In accordance with various embodiments, the RC device 180 may comprise an RC robot, robotic arm, RC rover, RC animal, or any other remote controlled apparatus (collectively referred to as RC device).

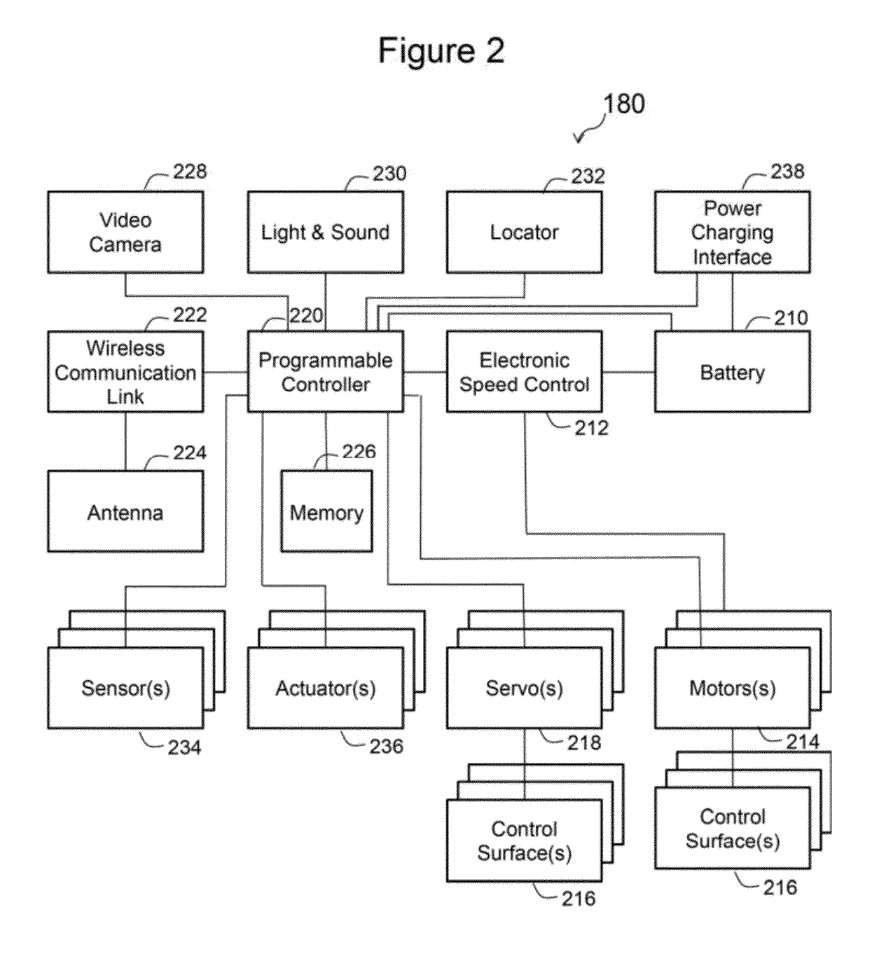

Referring to FIG. 2, in accordance with various embodiments, the RC device may comprise a battery 210, electronic speed control 212, motors 214, control surfaces 216, and servos 218. The battery 210 may be used to provide power to the RC device 180. The electronic speed control 212 may regulate the speed of the RC device 180 by adjusting power to the motor 214. The motor 214 typically drives control surfaces 216 such as wheels to provide forward and reverse motion. The servos 218 may be used to control the steering of the RC device 180.

In various embodiments, the RC device 180 may also comprise a programmable controller 220 and wireless communication link 222. The programmable controller 220 may comprise a single board controller 220. The programmable controller 220 and the wireless communication link 222 may be configured to allow the RC device 180 to connect to the RC network 170 and to receive and act upon commands sent by the controller 150.

The wireless communication link 222 may comprise a bi-directional link in communication. In various embodiments, the communication link 222 may comprise a WIFI adapter, a cellular radio, or any other suitable communication device. The wireless communication link 222 may be configured to allow the RC device 180 to connect to the RC network 170 in order to send and receive commands and transmit feedback and information. The wireless communication link 222 may also comprise an antenna 224 to aid in the transmission and reception of data.

The programmable controller 220 may comprise a circuit board comprising a processor, memory, input/output terminals, and any other components required for the programmable controller 220 to function. The sbc 220 may be configured to receive data and commands from the wireless communication link 222 and may operate in accordance with a program configured to interpret the commands stored in the memory 226. The commands received via the wireless communication link 222 may be interpreted by the programmable controller 220, adjusted in accordance with a user's profile settings and sent to the electronic speed control 212, motor 214, and servos 218.

In various embodiments, the RC device 180 may comprise a camera 228. The camera 228 may comprise a digital camera configured to record video from the perspective of the RC device 180. The camera may transmit the video to the programmable controller 220, which may then use the wireless communication link 222 to send the video to the user 110 or a viewer community.

In various embodiments, the RC device 180 may also comprise a light and sound circuit 230. The lights and sounds circuit 230 may, upon user command, activate a light configured to distinguish, the RC device 180 being controlled by the user 110. The light and sound circuit 230 may be configured to generate various sounds in response to a user's command. In various embodiments, the light and sound circuit 230 may be configured to generate a light or sound based on a trigger. The trigger may comprise any input configured to cause the display of light and/or sound. In various embodiments, the trigger may comprise a signal received by the programmable controller 220 via the wireless communication link 222.

In various embodiments, the RC device 180 may also comprise a locator 232. The locator 232 may be configured to determine the location of the RC device 180. The locator 232 may comprise any device capable of determining an accurate location of the RC device. For example, in various embodiments, the locator 232 may comprise a GPS receiver. In various embodiments, the locator 232 may be configured to provide the programmable controller 220 with a precise location of the RC device 180 and the programmable controller 220 may then use the wireless communication link 222 to send the precise location of the RC device 180 to the user 110 or a server.

In various embodiments, the RC device 180 may also comprise sensors 234 and actuators 236 for enhanced game play features. The sensors 234 may comprise proximity sensors, infrared sensors, light sensors, radio sensors, an impact sensor or any other sensor, in various embodiments, the sensors 234 may be configured to determine when the RC device 180 has come in contact or in close proximity to a hotspot, as will be discussed in detail below. In various embodiments, the sensors 234 may be configured to detect a tag signal that configured to receive a combat or laser tag types of input such as a infrared light, a laser, a radio frequency, a physical contact, or any other input.

The actuator 236 may comprise a device configured to trigger a sensor 234. The actuator 236 may comprise an infrared generator, a laser, a RF generator, a device launcher, a robotic arm, or any other device configured to trigger the sensor 234. The actuator may be controlled by the user 110 or by an outside device. In various embodiments, the sensor may comprise an IR detector and the actuator may comprise an IR generator. In various embodiments, the RC device 180 may have more than one sensor 234 on the device, which may be triggered by an actuator 236 or several types of sensors 234 that are triggered by several types of corresponding actuators 236. In various embodiments, the sensor 234 may be triggered by a hotspot.

A hotspot may comprise an actuator similar to the actuator 236 that may be located somewhere in the environment 140, but not on an RC device 180. For example, the hotspot may comprise an RF signal. In the event that the RC device 180 comes within a proximity of the hotspot, the hotspot may trigger a change in the operation of the RC device 180. For example, in various embodiments, a hotspot may be configured to cause a change in the operation of the RC device 180 such as an increase/decrease in the top speed of the RC device 180, an increase/decrease in the acceleration of the RC device 180, a change in the handling characteristics of the RC device 180, or cause the RC device 180 to stop. In various embodiments, the triggering of a sensor 234 by the hotspot may cause a change in a score associated with RC device 180.

In various embodiments, the sensors 234 may be configured to enable artificial intelligence (AI) enhancements to the RC device operation. For example, the sensors may be configured to provide an AI feedback regarding user 110 driving ability. The AI may subsequently enhance RC device controls to aid a novice user or diminish RC device controls to handicap an advanced user. In various embodiments, the AI may be configured to track hotspots that have been triggered and subsequently activate/deactivate hotspots and/or change the effects of hotspots.

In various embodiments, the RC device 180 may also comprise additional servos 218 and motors 214. In various embodiments, the additional servos 218 and/or motors 214 may be controlled by user. For example, in various embodiments, a servo 218 may control a shield to prevent a sensor 234 from being triggered by an actuator 236. In various embodiments, a motor 234 may be configured to control a robotic arm or other robotic control surface 216 which may be incorporated into the RC device 180.

In various embodiments, the RC device 180 may comprise a power charging interface 238. The power charging interface 238 may comprise an automatic interconnection of the RC device 180 with the charging station 850. The automatic interconnection may enable the RC device 180 to be charged without intervention. The programmable controller 220 may be connected to the power charging interface 238 and provide identification data to a server. The connection may provide the RC device 180 identification and battery 210 details to allow charging to be tailored to the battery 210.

In various embodiments, the RC device 180 may comprise a smart device. For example, in various embodiments, the programmable controller 220 may send device status alerts signaling that the RC device 180 requires maintenance. In various embodiments, the RC device 180 may recognize that the battery 210 is low and the RC device 180 may be configured to autonomously drive to the charging station 850.

### The Controller

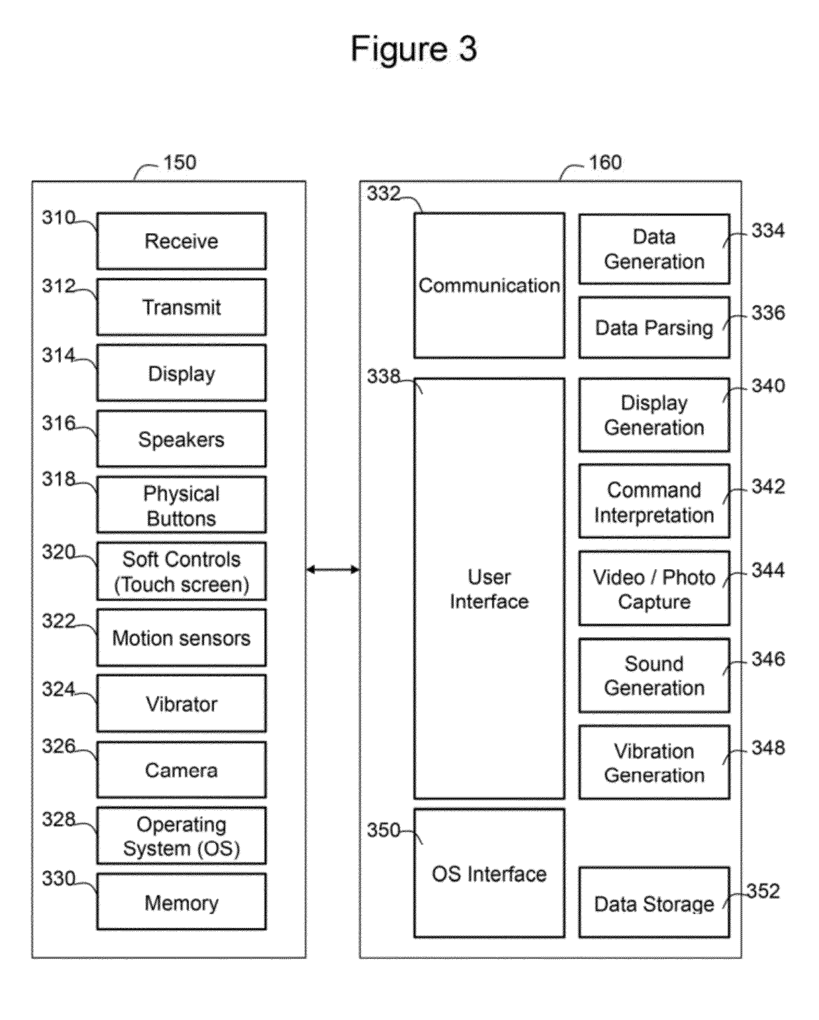

As shown in FIG. 3, the controller 150 may comprise any device configured to control the RC Device 180. For example, the controller 150 may comprise a conventional D-pad or analog stick based controller such as a Nintendo controller, a Playstation controller, a Xbox controller, or any similar controller. In various embodiments, the controller 150 may comprise a touch screen controller. With reference to FIG. 3, the controller 150 may comprise physical buttons 318, soft controls 320, motion sensors 322, a vibrator 324, and a camera 326. The controller 150 may also comprise a receiver 310, a transmitter 312, a display 314, an operating system 328, and a memory 330. In various embodiments, the soft controls 320 may comprise touch screen based controls. The controller 150 may comprise a multipurpose device such as a tablet computer or smart phone. The controller 150 may be configured to download and install the application 160. The controller 150 may be configured to run the application 160 which allows the controller 150 to connect to the RC device 180. The controller 160 may be configured to access and install the application 160 from a website or from art application store such as iTunes, the Android marketplace, Amazon or similar application stores. The controller 160 may also be configured to retrieve application updates. The application updates may be to fix bugs, improve stability, or to allow for new features.

### The Application 34

The application 160 may comprise any suitable software application that can be placed on the controller 150 and is compatible with the operating system 328. The application may be imbedded into the controller 150 or it may be installed onto the controller 150. The application 160 may also be downloaded to and installed on the controller 150. The application 160 may also be obtained via a hard copy such as a disk, thumb drive, or any other computer readable medium. The software may be stored in the memory 330 for retrieval upon request by the user 110. The application 160 may run on the controller 150 and be activated by the user 110.

In various embodiments, the application 160 may comprise a communication function 332, a data generation function 334, a data parsing function 336, a user interface 338, a display generation function 340, a command interpretation function 342, a video/photo capture function 344, a sound generation function 346, a vibration generation function 348, an OS interface 350, and a data storage 352. The application 160 may utilize the existing functional capabilities of the controller 150.

In various embodiments, the application 160 may communicate with the RC device 180 by utilizing the communication function 332. The communication function 332 may be performed by using the receiver 310 and transmitter 312 of the controller 150. The receiver 310 may receive information from the RC device 180 or from another device connected to the RC network 170, and may pass that information to the application 160 through the communication 332 function, which may parse the data using the data parsing function 336. Incoming information may then be parsed and used to generate the display using the display generation function 340 and the display 314, generate sound using the sound generation function 346 and the speakers 316, and to generate vibrations using the vibration generation function 348 and the vibrator 324.

In various embodiments, the received information may comprise but is not limited to videos, sounds, photos, vibrations, and messages. The received information may be generated by a server, video camera, the RC device 180, and/or other sensors, which may be incorporated in the user experience. For example, a server may generate an explosion graphic imposed over a video of the RC device 180 as well as vibrations, and additional sounds simulating screeching tires, expositions, crashes, and the like. The display video generation 340, sound generation 346, and vibration generation 348 may all be sent through the application's 160 user interface 338 to the display 314, speakers 316, and vibrator 324.

In various embodiments, the user interface 338 may be configured to utilize the existing functional capabilities of the controller 150 to determine the commands to be sent to the RC device 180. The operation of physical buttons 318, soft controls 320, and the motion sensors 322 may be captured by the user interface 338. The captured commands may then be converted into commands usable by the RC device 180 by the data generation function 334. The commands may then be sent to the communication function 332 and subsequently sent to the RC device using the receiver 310 and transmitter 312. For example, the user 110 may launch the application 160 by selecting an application icon on the soft controls 320. The user may then continue to use the soft controls 320 to interface with the RC device 180. In various embodiments, the application 160 may set-up the soft controls 320 with a touch slide, where the user may slide their finger to initiate an action. In various embodiments, the application 160 may have touch buttons 320 to activate RC device 180 functions. In various embodiments, the application 160 may set-up a joystick style touch spot to control the RC device 180. In various embodiments, the application 160 may accept commands from the physical buttons 318 of the controller 150 to perform some of the functions. In various embodiments, the application 160 may use the motion sensors 322 to generate commands for the RC device 180.

In various embodiments, the application 160 may be configured using various combinations of interface methods selected by the user, to allow the user to establish their personal preference. The configuration may be stored in data storage 352 and retrieved by the application 160 whenever the user activates the application 160. Based on the information received over the user interface 338, the command interpretation 342 function may translate the inputs into the commands necessary to control the RC device 180. The commands may be sent to the data generation 334 function so that they can be packaged into commands that the communication 332 function may deliver to the transmit function 312 and subsequently the RC device 180.

In various embodiments, the application 160 may allow for the control of information or transmission over existing wireless communication networks and/or the Internet. While the specific details of the data packaging may be unique based on particular controller 150, the data packaging may be transparent to the user 1.10. In addition, the application 160 may be able to receive data from various other devices connected to the RC network 170. For example, the application 160 may receive data from various servers and/or an RC device 180 over the same networks and/or the Internet. The transmission medium remains transparent to the user.

In various embodiments, the application 160 may map operation of the physical buttons 318 and soft controls 320 to various commands for different RC devices. For example, a directional pad on the controller 150 may control turning the wheels of a RC car left and right or the rudder of a RC airplane. Thus, the user 110 may be able to use the controller 150 to control any type of RC device 180.

A command may comprise any data sent by the application 160 that can be used to cause the RC device 180 or any other device connected to the RC network 170 to react. The RC device 180 may perform according to the data which has been transferred by the user 110. For example, a command may comprise data causing the RC device 180 to turn right, turn left, accelerate, or stop. In addition, the RC device 180 may send data back to controller. As the user 110 operates the controller 150, movements and motions which are captured by the application 160 may be packaged by the application 160 and transmitted by the controller 150 over the existing RC network 170.

In various embodiments, the application 160 may be configured to allow the user 110 to set and maintain preferences for the various types of RC devices 180. For example, the user may set a preference for a speed setting associated with a RC device 180. A novice user might desire to have the speed controlling function to be less sensitive and perhaps limit the top speed of the RC device 180. A more advance user may wish to have greater sensitivity to push the RC device 180 harder to obtain a higher level of performance. The novice user may select a speed setting configured to move the RC device 180 more slowly while the user learns how to control the RC device 180, whereas the experienced user may select a speed setting configured to allow the RC device 1180 to move faster. Other settings that may be adjusted include the electronic speed control 212, servo control 218 control surfaces control 216, sensors 234 and actuators 236.

In various embodiments, the application 160 may be configured to facilitate a selection of an RC device 180. The application may display the availability of various RC cars, trucks, boats, airplanes, helicopters, hovercraft, robots, and robotic control arms that are available for the user 110 to control. Once the user 110 has selected an RC device 180, the application 160 may cause the controller 150 to connect to that RC device 180.

In various embodiments, the controller may comprise a camera 326 that is capable of taking photos and videos. The camera may comprise any suitable digital camera that is capable of being placed on the controller 150. The user interface 338 may utilize the camera and give the user 110 an option to transmit a photo or video before, during or after the RC device 180 operation. In various embodiments, the camera 326 may comprise a rear facing camera and before and after photo or video may be taken and made available to devices connected to the RC network 170. In various embodiments, the camera 326 may comprise a front facing camera and before, during, and after photo(s) or video(s) may be taken and made available to devices connected to the RC network 170. The camera 326 may be operated by the video/photo capture 344 function to capture the photo(s) and/or video(s). The data may then be sent to data generation 334 and communication functions 332 for transmission.

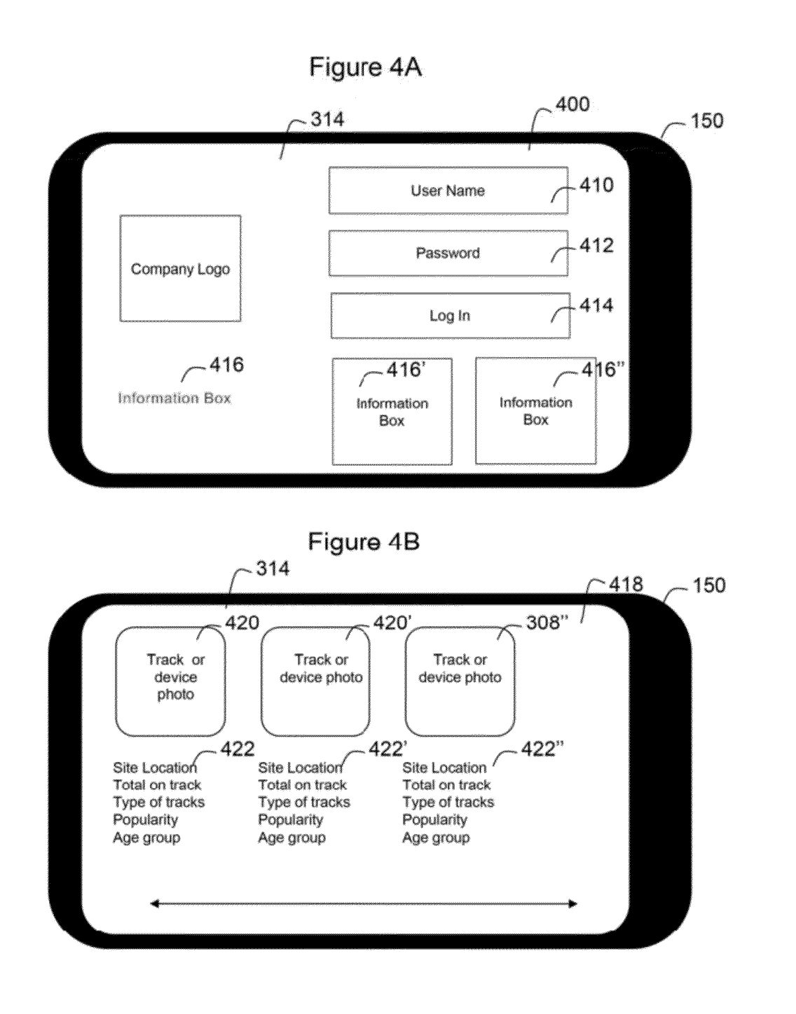

Referring now to FIGS. 4A and 4B and with continued reference to FIG. 3, the application 160 may be configured to have a login screen 400 and a selection screen 418. In various embodiments, when the user 110 first activates the application 160, the login screen 400 may be displayed by the user interface 314. The login screen may comprise a username box 410, a password box 412, a login button 414, and an information box 416, 416′, 416″.

In various embodiments, the user 110 may be required to enter their user name 402 and password 412 to gain access to their account. This information may be retrieved through use of physical buttons 318 or soft controls 320 features of the controller 150. The user may then activate the login by selecting the login 414 button which is generated through physical buttons 318 or soft control 320 features. Upon login, the user may be subject to a selection screen 418.

The selection screen 418 may comprise an environment/device photo 420, 420′. 420″ and an environment description 422, 422′, 422″. The environment description 422′, 422′, 422″ may comprise the location of the environment, the number of users/RC devices active in the environment, the type of environment, the popularity of the environment, any age/skill restrictions on the environment, and any additional information which may be relevant for the user to make their selection.

In various embodiments, the controller 150 may receive information about the types of RC devices 180 and types of environments 140 that are available. While the number of environments and devices shown in the perspective view is three, it should be understood that the selection screen 418 is scalable to allow for any number of depictions. In various embodiments, when the available environments 140 or RC devices 180 exceeds the visibility area on the display 314, additional pages may be accessed using physical buttons 318 or soft controls 320. Based on the type of controller 150, additional pages may be accessed using physical buttons 318 or soft controls 320. In various embodiments, when using a controller 150 with soft controls 320, the user would be able to use a soft touch 320 slide feature to move the display 314 on to next set of information. In various embodiments, when a user 110 decides on an RC device 180, the user may tap the photo 420, 420′, 420″ depicting the desired environment 140 or RC device 180. In various embodiments, when a user 110 decides on an RC device 180, the user may press a physical button 318 to finalize the RC device 180 selection. After selecting an environment/RC device, the application 160 may provide the user 110 with an operation screen.

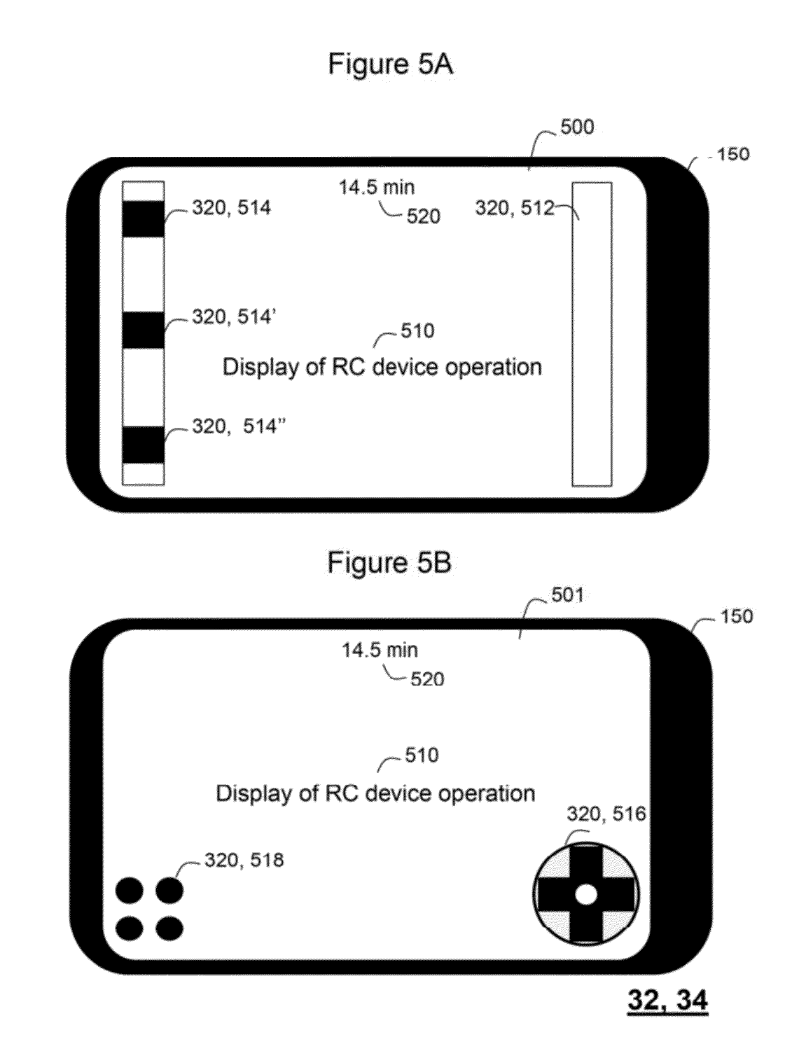

Referring now to FIG. 5A, in various embodiments, the operation screen 500 may comprise video 510, a display item 520, and soft controls 320. In various embodiments, the soft controls 320 may comprise a touch slide 512 and soft buttons 514.

In various embodiments, the display 314 may exhibit the video 510 of the RC device 180 in operation. Video information may be received from the camera 228 and formatted by the display generation 340. The soft buttons 514 and the touch slide 512, may be transparent on top of the video. These soft controls 320 may be generated by the application 160 as part of the display generation 340 function.

In various embodiments, the controller 150 may comprise motion sensors 322 configured to control the steering of the RC device 180. The motion sensors 322 may be monitored by the application 160 and command interpretation 342 may be performed to determine steering commands for the RC device 180. For example, in various embodiments, if the user tilts the controller 150 to the right, the RC device 180 will steer towards the right and if the user tilts the controller 150 to the left, the RC device 180 will steer towards the left.

In various embodiments, acceleration may be controlled by sliding a finger along the touch slide 512. For example, in various embodiments, a user 110 sliding a finger up the touch slide 512 increases the acceleration on the RC device 180 and sliding, a finger down the touch slide 512 decreases the acceleration on the RC device 180. In various embodiments, the soil buttons 514 may be used for additional game play which will be used to implement advance gaming features 1050.

In various embodiments, the soft button 514 may be assigned to control the actuator 236 and the button 514′ may be assigned to control the control surface 216. While the perspective view of FIG. 5A shows touch slide 512 soft control 320 on the right and soft buttons 514, 514′, 514″ soft controls 320 on the left, it should be understood that these position may be exchanged to maximize the user comfort with the controls.

Referring now to FIG. 5B, in various embodiments, the operation screen 501 may comprise video 5100, a display item 520, and soft controls 320. In various embodiments, the soft controls 320 may comprise the direction pad 516 and the soft buttons 518. In various embodiments, the display item 520 and the soft controls 320 may be overlaid on top of the video 510. In various embodiments, the display item 520 and the soft controls 320 may be semi-transparent so that the video 510 beneath them may still be viewed.

In various embodiments, the direction pad 516 may function to provide both steering and acceleration commands for the RC device 180. For example, in various embodiments, acceleration may be accomplished similar to the touch slide 512. When the user's finger moves up on the direction pad 516, the RC device 180 accelerates and when the user's finger moves down, the RC device 180 decelerates. In various embodiments, when the user's finger moves to the right, the RC device 180 steers to the right, and when the user's finger moves to the left, the RC device 180 steers to the left. The user may also select user preferences for this control method to adjust control sensitivity and layout. The user's finger movement on the direction pad 516 may be monitored by the application 160 and command interpretation 342 is performed to turn the finger movement into commands for the RC device 180. FIG. 5B shows the direction pad 516 as only a small corner of display 314. In various embodiments, the entire display 314 surface may be used as the controlling surface for the RC device 180, with commands being interpreted for movement based on the finger movement over the entire soft control 320 area. The soft buttons 328 may perform similar functions to the soft buttons 514. The soft buttons 328 may be located anywhere on soft controls 320.

In various embodiments, the display item 520 may be overlaid on top of the display of video 510. In various embodiments, the display item 520 may comprise a timer that may be either count up or count down. In various embodiments, the display item 520 may comprise a race position (1^{st}, 2^{nd}, last) or a points score. The information displayed by the display item 520 may be generated by any suitable source. For example, in various embodiments, the application 160 or an outside source may generate the information shown by the display item 520. In various embodiments, the outside source may comprise the RC device 180, an outside server, or another controller 150. In various embodiments, the display generation 340 function may interpret any information generated by an outside source place it appropriately on the display 314. Although FIGS. 5A and 5B only show a single display item 520, it should be understood that there may be multiple display items comprising multiple pieces of information.

### Server Introduction

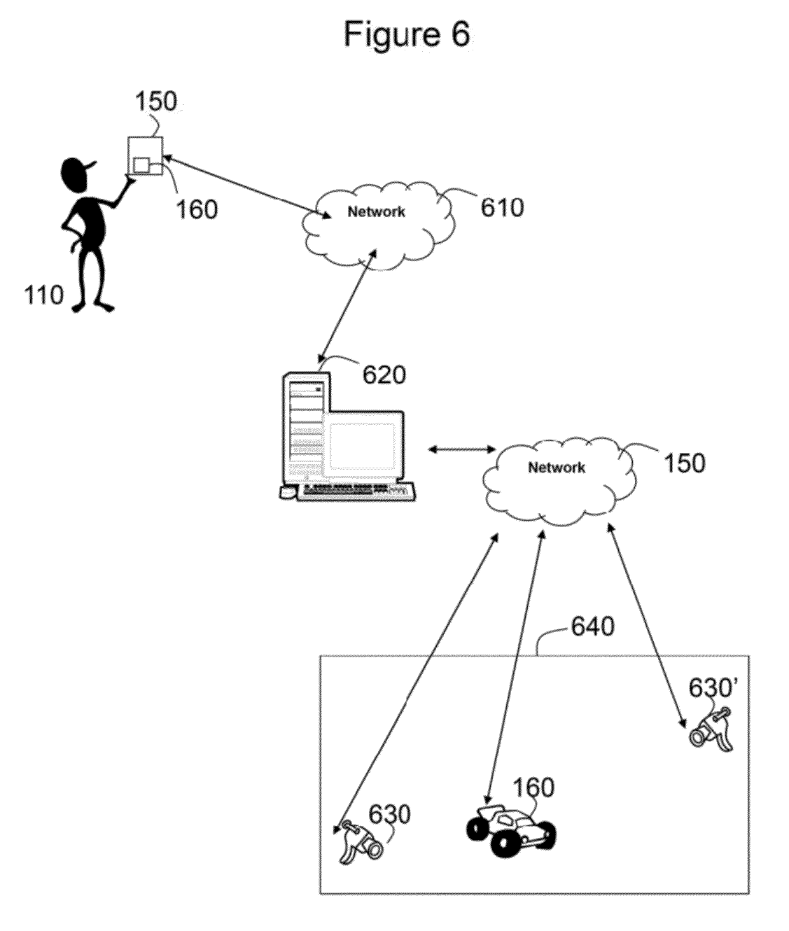

Referring now to FIG. 6, in various embodiments, the RC system may comprise the user 110, the controller 150 running the application 160, the network 610, the device server 620, the RC network 170, the environment 640, the RC device 180, and at least one camera 630, 630′. In various embodiments, the controller 150 may connect to the device server 620 via the network 610. The device server 620 may then connect to the RC device 180 via the RC network 170 and relay any commands and feedback between the controller 150 and the RC device 180. In various embodiments, the RC device 180 may be located remotely from the user 110 and the user may view the RC device 180 using a camera 630, 630′ or the camera 228 located on the RC device 180.

### The Network 610

In various embodiments, the network 610 may comprise any suitable computer network for connecting controller 150 to the device server 620. For example, the network 610 may comprise a WIFI network, the Internet, a Bluetooth connection, RF, cellular network, or a low power wireless network designed for short range communication of encoded data.

### The Video Cameras

In various embodiments, the cameras 630, 630′ may be configured to capture the RC device and transmit the appropriate video feed to the device server 620 via the RC network 170. The cameras 630, 630′ may comprise any suitable digital video camera that is either capable of directly transmitting video to the device server 620 or may be connected to a device capable of transmitting video to the device server 620. In various embodiments, the location of the RC device 180 may determine which video is sent to the user. The location of the RC device may be determined by the device server 620, the cameras 630, 630′, or by the locator 232. For example, in various embodiments, a program running on the device server 620 may be used to allow the video to switch appropriately to ensure that the user 110 is able to follow their RC device 180 in operation. In various embodiments, the user 110 may select the camera view that is displayed via the controller 150.

### The Server

The device server 620 may comprise any suitable server configured to connect to the RC device 180, controller 150, cameras 630, 630′, and the network 610 and/or the RC network 170. The device server 620 may be configured to act as an intermediary between the networks. For example, in various embodiments, the device server 620 may be connected to the controller 150 via the network 610 and may also be connected, to the RC device 180 via the RC network 170. The device server 620 may receive commands from the controller 150 and relay the commands to the RC device 180. Similarly, the device server 620 may receive data/feedback from the RC device 180 and relay that data to the controller 150. The device server 620 may collect environment data and relay the data to the controller 150 and/or the RC device 180. The device server 620 may also receive video data from one or more video cameras via the network 170 and relay that data to the controller 150 via the network 610.

In various embodiments, the device server 620 may provide information to the application 160 regarding the commands/controls and instructions necessary to control the RC device 180. For example, if the RC device 180 comprises a RC helicopter, the controls required to operate the RC helicopter differ from the controls of a RC car. Thus, the device server 620 may alert the application of the type of RC device and the application 160 may configure the controller 150 to enable the user 110 to control the RC device 180.

In various embodiments, the device server 620 may be configured to accommodate many different types and styles of controllers 180, enabling multiple users to operate RC devices 180 simultaneously without regard for the type of controller 180. For example, in various embodiments, the device server 620 may be configured to connect to smart phones or smart tablets with Android operating system, or Apple operating system, or other mobile device operating systems, as well as a PC, gaming consoles, such as Nintendo, Xbox, or Playstation consoles, or any other suitable controller.

### Additional Server Functions

The server may be configured to provide a series of functions. For example, the server may determine a user's eligibility, select a environment, select an RC device 180, provide connectivity to the RC device 180, send commands to the RC device 180 from the controller 150, provide feedback from the RC device 180 to the controller 150, provide feedback from a facility to the controller 150, control features, determine a controller latency, stream video, run AI to control multiple RC devices, add assistive AI, and provide the user with additional information relating to the RC device 180.

### Multiple Users and Multiple Environments

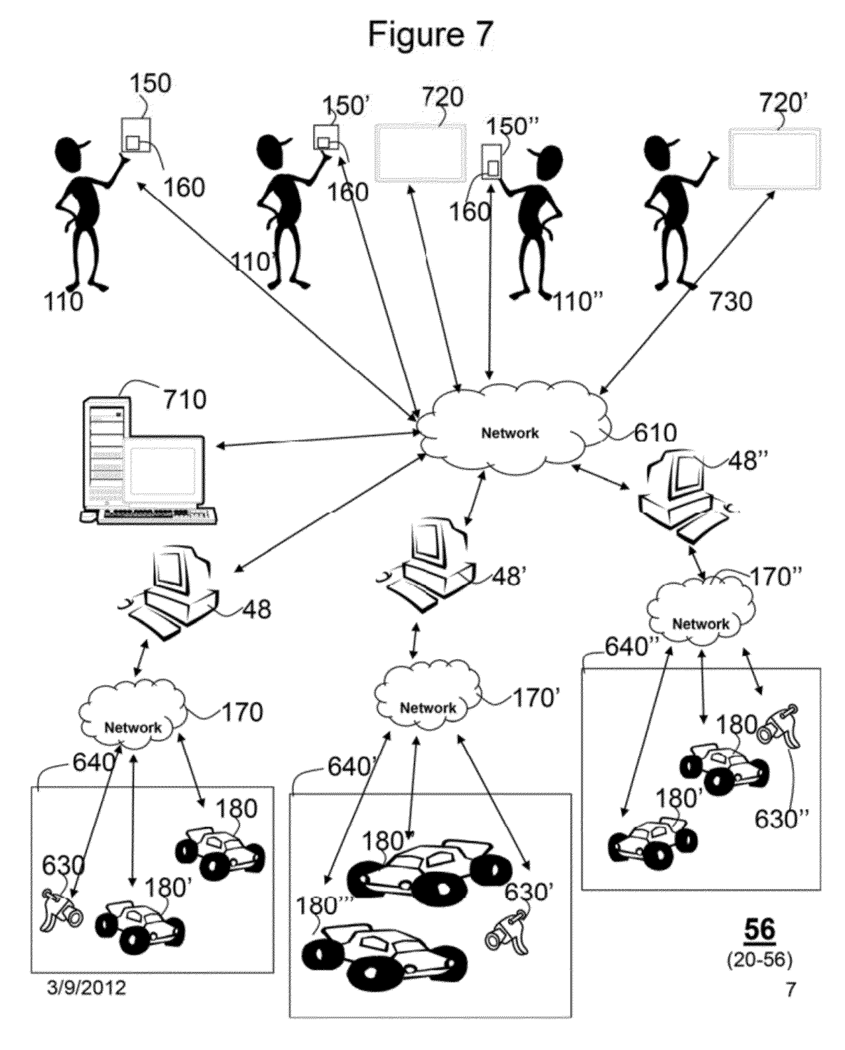

With continued reference to FIG. 6, FIG. 7 multiple users 110, 110′, 10″ may control various RC devices 180, 180′, 180″, 180′″, located at various environments 640, 640′, 640″. Users 110, 110′, 110″ may be located anywhere in the world, as long as their controller 150, 150′, 150″ have access to the network 610 and the RC network 170. The location of the user 110 may be in motion, such as on a subway or plane, or stationary, such as inside or outside of building. The users 110, 110′, 110″ may be alone or with other users 110 and may utilize their own individual network connections or share a single network connection. The controllers 150, 150′, 150″ may access the gateway server 710 for login, authentication, and access to the device servers 620, 620′, 620″ for selection and operation of any RC device 180, 1180′, 180″ at any environment 640, 640′, 640″.

In various embodiments, multiple users 110′ and 110″ may be co-located and the video from the environment 640′ video camera 630, 630′ onto a monitor 720 in addition to having the video on their individual controllers 150′, 150″. The monitor 720 may comprise a computer monitor, a TV or any other display device. In various embodiments, the monitor 720 may be connected to the network 610 via an onboard network adapter, a gaming console, tv set-top box, a bin-ray player, or any other device configured to provide the monitor 720 with network connectivity,

### Viewers

In various embodiments, viewers 730 may watch the video from the environments 640, 640′, or 640″. In various embodiments, the viewers 730 may select a RC device 180 to view based upon the user controlling the RC device or may select an environment to view.

It should be understood that the system depicted in FIG. 7 may be scalable such that an unlimited number of users may access to a network with an unlimited number of environment facilities with an unlimited number of RC devices that may be located throughout the world.

In various embodiments, the server may be configured to broadcast video from the various environment facilities to a video network. The video network may be viewable by any viewer 730. In various embodiments, the user 110 may invite another user 22′ or a viewer 730 to watch or to join them by controlling another RC device at the same environment facility. A click-thru feature may provide invitees with quick access to the facility site of the user. A click-thru feature when watching may allow users 110 to join an on-going activity or special event at a environment facility.

### The RC Environment

The RC environment 640, 640″, 640″ may comprise any environment containing the RC device 180 and may be located in any location accessible by the networks 610 and the RC network 170. In various embodiments, the user 110 may control an RC device 180 in various different environments 640, 640′, 640″ which may be located anywhere in the world. Each environment 640, 640′, 640″ may comprise various tracks, games, arenas, and features.

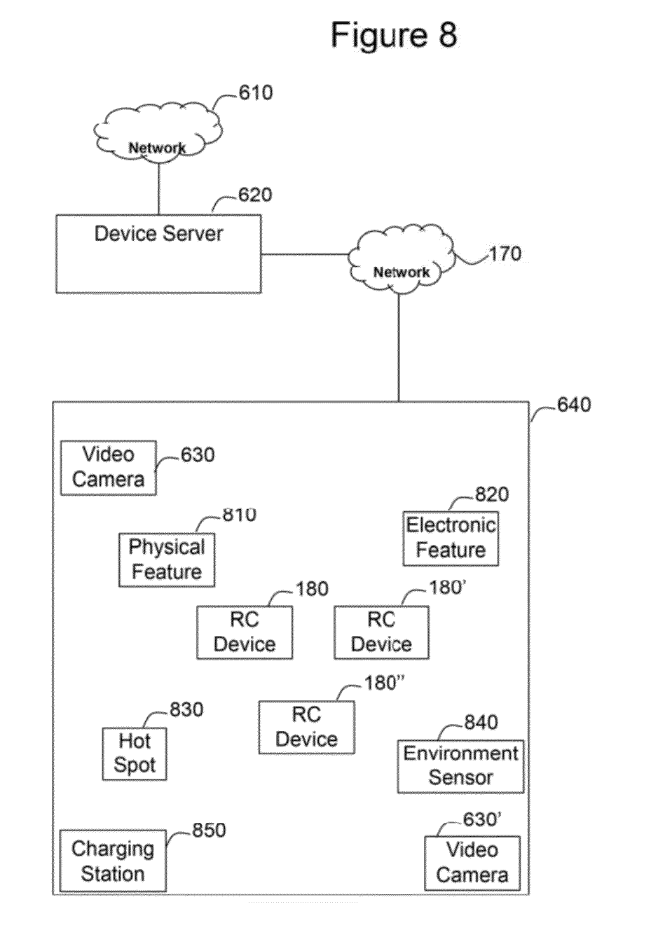

Referring now to FIG. 8, in various embodiments, the environment 640 may be defined as an area within which the RC device 180 may operate. The environment 640 may be inside and/or outside, may be small or large, and may be anywhere in the world. The environment 640 may comprise the device server 620, the RC network 170, the RC device 180, 180′, 180″, the video camera 630, 630′, a charging station 850, a physical feature 810, an electronic feature 820, a hotspot 830 and an environment sensor 840. In various embodiments, the device server 620 may be located within the environment 640 or may be located remotely. The environment 640 may comprise the video cameras 630, 630′ which view the RC device 180. Live video may stream from the video cameras 630, 630′ to the device server 620 and then over the network 610 to the controller 150 or directly from the video camera 630), 630′ to the controller 150.

In various embodiments, the environment 640 may be configured to allow multiple RC devices 180, 180′, 180″ to operate simultaneously. The number of RC devices 180 which operate simultaneously may be environment 640 dependent, based on size of the environment 640 and type of RC device 180 being used.

In various embodiments, the environment 640 may comprise a charging station 850 for the RC devices 180. The charging station 850 may be configured to recharge RC devices 180 that are not in operation. In various embodiments, the device server 620 may be configured to control the charging of RC devices 180 at the charge station 850. For example, the RC devices 180 may be identified by the device server 620 to be recharged, and the device server 620 may issue commands to the RC device 180 directing it to the charging station 850. The power charging interface 238 on the RC device 180 may mate to the charging surface on the charging station 850. The device server 620 may acknowledge the mating to the RC device 180, identify the RC device 180, and deliver the appropriate charging profile to the RC device 180.

In various embodiments, the device server 620 may be configured to control an environment enhancement for the environment 640. The environment enhancements may comprise physical features 810, electronic features 820, and hotspots 830.

In various embodiments, the physical features 810 may comprise any shape or size and variety of physical features. In various embodiments, the physical feature 810 may comprise water, rocks, paved surfaces, dirt surfaces, grass surfaces, walls, bridges, ramps, speed bumps, turnstiles, and/or other physical elements.

In various embodiments, the environment 640 may comprise physical features 810 and electronic features 820. The electronic features 820 may comprise movable surfaces which may be controlled electronically to alter the physical environment for RC devices 180. In various embodiments, the electronic feature 820 may comprise at a drawbridge, lane change gate, crane, robotic arm, fan, lights, or a sound generation device. The environment 640 may comprise any number of physical features 810 and electronic features 820.

In various embodiments, the hotspot 830 may comprise an area that, when a RC device 180 enters into or comes in close proximity to, triggers an event. Any number of hotspots 830 may be imposed within the environment 640. In various embodiments, the hotspots 830 may change continuously while a user is operating the controlling RC device 180. The hotspots may be detectable by the RC device 180 and/or device server 620 and may or may not be visible to the user 110.

In various embodiments, the hotspot 830 may trigger a reward. For example, the reward may comprise points. Thus, when the RC device 180 enters the hotspot, points are added to the user's account on the device server. In various embodiments, the reward may comprise a special power, such as a turbo boost to accelerate a RC device vehicle or a strength boost to enhance power for a robotic style RC device. In various embodiments, the reward may comprise a power boost, such as added acceleration for a RC vehicle or added strength for a RC robot.

In various embodiments, the hotspot may trigger a trap. The trap may comprise a speed penalty that causes the programmable controller 220 to slow down or stop the RC device 180 for a specified period of time. In various embodiments, the trap may comprise an “ice patch” whereby triggering the hotspot results in programmable controller 220 modifying the steering of the RC device 180 to be looser and not responsive. In various embodiments, the device server 620 may determine if the hotspot is a reward or a trap and may move the location(s) of the hotspot(s) 830. In various embodiments, aiming spots may be set up for a laser tag or combat type of simulation environment into which a RC device's 180 user may choose to operate. In various embodiments, proximity zone hotspots 830 may also be set up for feature course or treasure hunt style of courses into which a user may operate the RC device 180.

In various embodiments, the device server 620 may use the precise location determined by the locator 232 or may determine the location of the RC device 180 using the environment sensor 840. The environment sensor 840 may comprise an electronic grid, a magnetic grid, an optical sensor within the environment area, an optical camera over the environment area, a wireless ranging sensor, and similar types of location enhancing techniques. In various embodiments, the environment sensor 840 may be configured to detect if the RC device 180 has gone outside the environment 640 or entered a restricted area. In various embodiments, the environment sensors 840 may be configured to determine if there is a problem with the environment 640. These techniques may include incorporation into the RC device 180 and the device server 180 for further user experience enhancements.

The cameras 630, 630′ may comprise video cameras that have been positioned around the environment 640 to capture the RC device 180 as it moves around the environment 640. The video cameras 630, 630′ may be located around the edge of the environment 640, overhead of the environment 640, or elsewhere within the environment 640. The device server 620 may receive all the video from the various video cameras 630 positioned around the environment 640 and the camera 228 located on the RC device and route the appropriate video to the appropriate controller 150 and/or monitor 720, 720′.

### Gateway Server 710

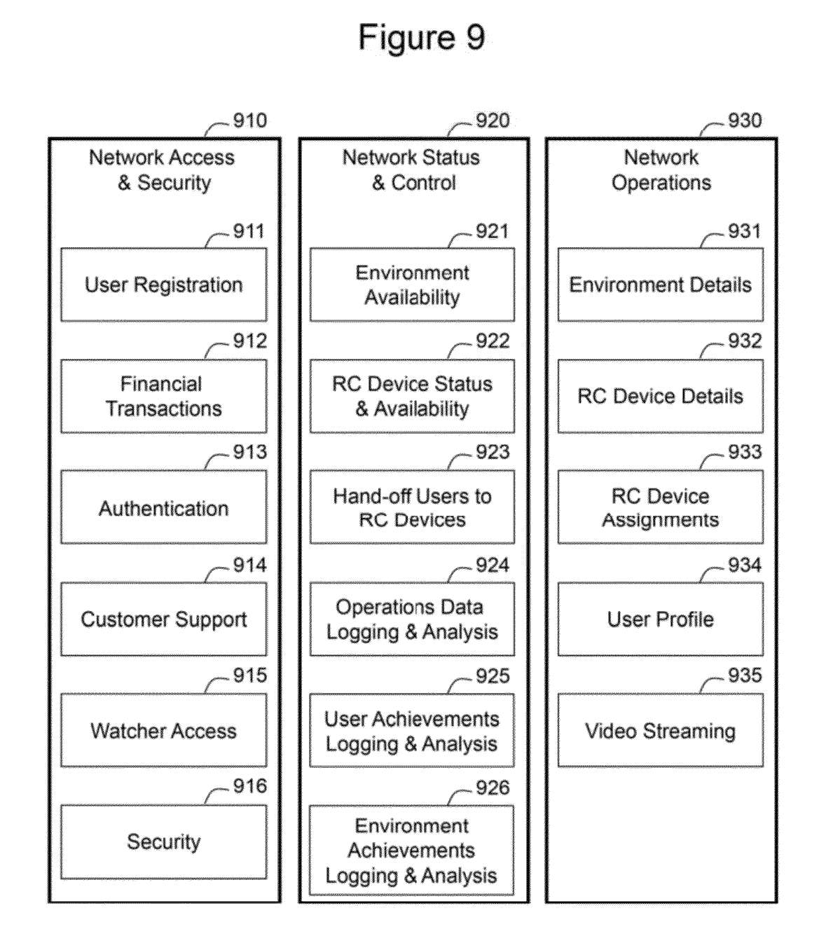

Referring now to FIG. 9, in various embodiments, the gateway server 710 may comprise an access function 910, a control function 920, and an operations function 930.

In various embodiments, the access function 910 may comprise functions involved in gaining access to the system. For example, in various embodiments the access function 910 may comprise a user registration function 911, a financial transactions function 912, an authentication function 913, a customer support function 914, a viewer access function 915, and a security function 916.

In various embodiments, the access function 910 comprises the user registration function 911. The user registration function 911 may be configured to allow the user 110 to gain access to the system. The user 110 may be required to access the system with a user name and password. Upon registration, users will be able to purchase usage time for the RC device 180.

In various embodiments, a user may purchase usage time using the financial transactions function 912. The financial transaction function 912 may comprise a secure connection for a financial transaction utilizing bank accounts, credit cards, or or any other means of making an electronic transaction.

In various embodiments, the authentication function 913 may be configured to enable the user to continually return to the system and access their user profiles and usage time.

In various embodiments, the access function 910 comprises a customer support function 914. The customer support function 914 may be configured provide information to the user 110 and/or a potential user regarding various RC device usage plans that are available for purchase, the various types of RC devices available, and the various environment facilities available. New environments and promotions may also be available through the customer support function 914. In various embodiments, the customer support function 914 may also provide assistance to user 110 regarding account details, technical issues, or other problems that user may encounter.

In various embodiments, the access function 910 comprises a viewer access function 915. The viewer access function 915 may allow non-users to sign-up to watch the RC devices 180 in operation, similar to a social network for people interested in watching the interaction of the RC devices 180.

In various embodiments, the access function 910 may comprise a security function 911. The security function 916 may provide security for the network by monitoring for malicious activity to ensure a secure environment for the system.

In various embodiments, the gateway server 710 may comprise a control function 920 configured to maintain the status and control over the network. For example, in various embodiments the control function 920 may comprise the environment availability function 921, the RC device status function 922, the hand-off function 923, the operations analysis function 924, the user achievement function 925, and the environment achievements function 926.

In various embodiments, the environment availability function 921 may maintain control over which environments 640 are available. The availability of an environment 640 may be based on the operating schedule of the environment 640. While some environments 640 may support 24 hour access, others may have a shorter operating schedule. In addition, some environments 640 may also go off-line for upgrades or maintenance.

In various embodiments, the RC device status function 922 may keep track of which RC devices 180 are available for operation. The RC device 180 may be unavailable due to maintenance, failure, or it may be in use by another user. The RC device status function 922 may be configured to ensure a user 110 does not attempt to connect to a device that is unavailable.

In various embodiments, the hand-off users to hand-off function 923 may provide the users with information regarding the availability of the RC device 180 and facilitate the connection of the user's control to the RC device 180. The users may select a RC device 180 by device type, environment type, environment location, or other variables. The user 110 may continue through the RC device selection process until the user 110 selects a specific RC device. When the RC device 180 is selected, the user is handed off to the operations analysis function 924. The operations analysis function 924 may be configured as a logging and analysis feature to ensure the network operates smoothly and to its fullest capacity. Usage traffic, peak traffic, favorite facilities, favorite RC device types, and favorite environment types, as well as other parameters may be monitored to ensure efficient operation of the network.

In various embodiments, the user achievement function 925 may track, log, and analyze user achievements, playtime, preference, and other data relevant to user 110. The user achievement function 925 may analyze the logged data and determine rewards, advancement, and other opportunities to be given to the user. In various embodiments, the user achievement function 925 may also be utilized to by the environment availability function and the RC device status function 922 to determine if a user meets the skill requirements to use a RC device 180 and/or an environment 640.

In various embodiments, the environment achievements function 926 may track, log, and analyze environment data, including but not limited to highest speed, minimum course completion time, and other records which will be maintained as environment records for users to achieve. The environment achievements function 926 may analyze data recorded to determine when maintenance or corrections to the environment are necessary. In various embodiments, the environment achievements function 926 may also be utilized to by the environment availability function and the RC device status function 922 to determine if a user meets the skill requirements to use a RC device 180 and/or an environment 640.

In various embodiments, the operations function 930 may provide the operation functions for the network. In various embodiments, the operations function 930 may comprise environment details 931, RC device details 932, RC device assignments 933, a user profile 934, and video streaming 935.

In various embodiments, the environment details function 931 may contain information on the various environments 640, including number of environments, types of environments, types of devices, operating hours, and similar type of operational data.

In various embodiments, the RC device details function 932 contains information of each RC device 180 in every environment 640 in the system 56. The RC device 180 details may include device type, operating time (between power charges), operating time left, control requirements, serial numbers, and health status.

In various embodiments, the RC device assignments function 933 may link the user to the specific environment 640 and RC device 180 assigned by network status & control 124.

In various embodiments, the user profile function 934 may be configured to store and modify the system according to a user profile. User profiles may include the ability to store favorite environment sites, favorite RC device types, and RC device set-up information. The profile may also store AI preferences, such as a novice user designation requesting computer assistance. The profile may also store any contest wins and associated standing with relation to those wins. The user profile function 934 may decrement the user's usage time based on minutes of use.

In various embodiments, the video streaming function 935 may forward video captured by the cameras 630, 630′, 228 to the controller 150. The video streaming function 935 may provide assignments of videos associated with particular environments 640 and RC devices 180. The video streaming function 935 also may perform allocation of video streams captured by the cameras 630, 630′, 228 to users and viewers 730.

### Device Server 620

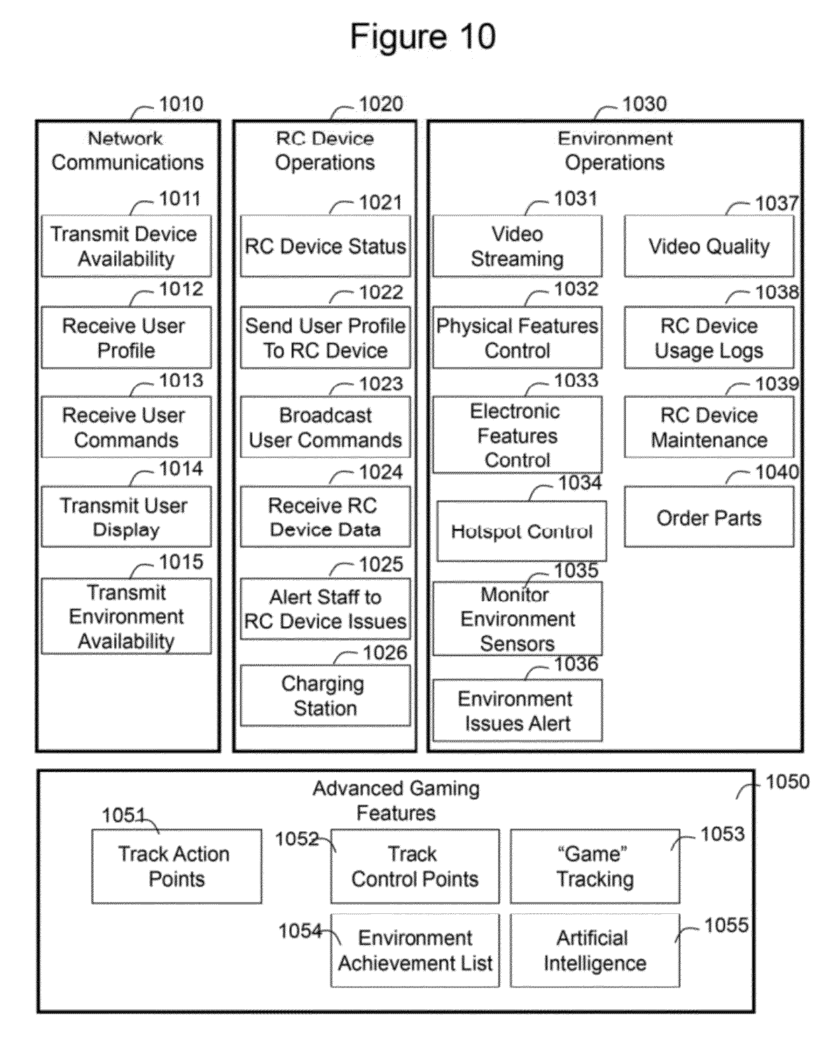

Referring now to FIG. 10, in various embodiments, the device server 620 may to be configured for network communications 1010, RC device operations 1020, environment operations 1030 and advanced gaming features 1050. The device server 620 may be located in the environment 640 or at a remote location. In various embodiments, device server 620 may provide services for multiple environments 640.

In various embodiments, the network communications function 1010 is configured to provide for communications with the gateway server 710 and the controller 150. In various embodiments, the network communication function 1010 comprises a transmit device availability function 1011, a receive profile function 1012, a receive commands function 1013, a transmit display function 1014, and a transmit environment availability function 11015. In various embodiments, the transmit device availability function 1011 may send information to the gateway server 710 regarding status of the RC devices 180. In various embodiments, the receive user profile function 1012 may be configured to receive information from the gateway server 710 regarding the RC device 180 assignment and the user profile associated with the RC device 180 assignment.

In various embodiments, the receive user commands function 1013 may receive commands from the controller 150. The receive user commands function 1013 may be configured transmit the commands to the RC device 180 which has been assigned to the user 110.

In various embodiments, the transmit user display function 1014 may be configured to receive video from the cameras 630, 630′, 228 and transmit the video to the controller 150 or the monitor 720.

In various embodiments, the transmit environment availability function 1015 may be configured to transmits information on an operating status of an environment to the gateway server 710. The operating status may comprise an environment availability, a race time, a down time, an environment modification, and advertising.

In various embodiments, the RC device operation function 1020 may be configured to maintain all information regarding all RC devices 180 that can connect to the device server. In various embodiments, the RC device operation function 1020 may provide access to the RC Network 170 and form a bi-directional communication link between the device server 620 and the RC device 180. In various embodiments, the RC device operations function 1020 comprises an RC device status function 1021, a send user profile function 1022, a Broadcast commands function 1023, a receive RC device data function 1024, an alert function 1025, and a charging station control 1026.

In various embodiments, the RC device status function 1021 may be configured to determine the health of the RC device 180, a status of the RC device 180, a location of the RC device 180, and other information regarding the RC device 180. In various embodiments, the RC device status function 1021 also maintains status on the battery 210 of the RC device 180 and may determine when the battery 210 needs to be charged or replaced.

In various embodiments, the send user profile to RC device function 1022 may be configured to push a user profile to the RC device 180 so that the RC device 180 will operate according to the user profile.

In various embodiments, the broadcast user commands function 1023 may be configured to broadcast commands sent from the controller 150 to the RC device 180 via the RC network 170. The broadcast user commands function 1023 may be configured so that the command is only sent to the appropriate RC devices 180.

In various embodiments, the receive RC device data function 1024 may be configured to receive any data being sent by the RC devices 180 via the RC Network 170. In various embodiments, the data may comprise battery status, device problems, device location, device status, and video (visual & sound)

In various embodiments, the alert function 1025 may be configured to alert a staff member of any problems associated with an RC device 180. For example, an alert may be created if the RC device 180 has: a low battery, a dead battery, is unable to move (stuck, in a corner, physical damage, rolled over, etc), a control surface, servo, actuator, or motor is malfunctioning, a sensor is malfunctioning, or any other type of problems.

In various embodiments, the charging control 1026 may be configured to control the charging of the battery 210 of the RC device 180. The charging control 1026 may be configured to ensure that the battery 210 is charged in a substantially optimal manner. In various embodiments, the charging control 1026 may provide commands to the RC device 180 directing the RC device 180 to the charging station 850. In various embodiments, the charging control may be activated upon an alert generated by the alert function 1025.

In various embodiments, the environment operations function 1030 may be configured to control the environment 640 in which the RC devices 180 are operating. The environmental operations function 1030 may comprise a video streaming function 1031, a physical features control function 1032, an electronic features control function 1033, a hotspot control 1034, monitor environment sensors function 1035, and environment issues function 1036. In various embodiments, the environments operations function 1030 supports all the environments connected to the device server 620.

In various embodiments, the video streaming function 1031 is configured to receive all of the video being recorded and to stream the video over the network 610 to the controller 150 and the monitor 720. The video steaming function may be configured to receive video from the environment camera 630, the RC device camera 228 and the controller camera 326.

In various embodiments, the environment operations 1030 function may be configured to control physical features 810, electronic features 820, and hotspots 830 using the physical feature control 1032, the electronic feature control 1033, and the hotspot control 1034. In various embodiments, the physical feature control 1032, the electronic feature control 1033, and the hotspot control 1034 may activate the physical features 810, electronic features 820, and hotspots 830 at preprogrammed intervals. In various embodiments, the activation may be commanded by the viewers 730.

In various embodiments, the monitor environment sensors function 1035 may be configured to environment sensors 840 positioned around and within the environment 640. In various embodiments, the monitor environment sensors function 1035 may be fully automated and thus enable the environment 640 to be operated with minimal staff.

In various embodiments, the alert staff to environment issues function 1036 may be configured to alert staff to issues with the environment 640 found by the monitor environment sensors function 1035. In various embodiments, the staff to environment issues function 1036 may be configured to send prioritized notifications regarding environment 640 issues.

In various embodiments, the environment operations function 1030 may be further configured to ensure that the environment 1640 is running smoothly. In this embodiment, the environment operations function 1030 my further comprise a video quality function 1037, an RC device usage log 1038, a RC device maintenance function 1039, and a parts ordering function 1040.

In various embodiments, the video quality 1037 function ensures that the video being transmitted to the users and viewers is correct and is of adequate quality.

In various embodiments, the RC device usage logs 1038 may be configured to provides a usage log of each RC device's operation. Similarly, in various embodiments, the RC device maintenance function 1039 may review the usage logs and determines when maintenance needs to be performed on RC device 180. For example, in various embodiments, in the case of a RC car, the car will require tires to be replaced. When the tires need to be replaced will depend on the usage of the vehicle, with high speed aggressively driven vehicles requiring tire replacement sooner than slower driven vehicles.

In various embodiments, the order parts function 1040 provides inventory control over spare parts and may project when RC device 180 problems will require additional parts to be ordered. For example, RC device 180 batteries may need to be replaced after a specific number of runtime hours or when the battery 210 is not longer maintaining a charge. The order parts function 1040 may be configured to analyze the RC device usage logs 1038 and place an order for a new battery 210.

In various embodiments, the advanced gaming features function 1050 may be configured to allow advanced gaming features to be implemented in the environment 640. In various embodiments, the advanced gaming features function 1050 may comprise a track action points function 1051, a track control points function 1052, a game tracking function 1053, an achievements function 1054, and an artificial intelligence function 1055.

In various embodiments, the track action points 1051 may enable the placement of hotspots 830 and/or environment sensors 840 where the RC device 180 may be required to perform certain actions. In various embodiments, the track control points function 1052 may be configured to track the placement of points where the RC device 180 is delivered a set of server-generated control commands. In various embodiments, the track action 1051 and control 1052 points are hotspots where the device server 620 may impose additional requirements or commands on the RC device 180 in addition to the controls that the RC device's 180 user is generating. For example, in the case of a RC car, a hotspot 830 might be set up to simulate ice on the road. The RC device 180 would receive a command from the device server 620 to disrupt the steering on the car to simulate hitting an ice patch. As another example, a turbo boost spot may be established, where the RC device 180 would suddenly have additional speed. The hotspots 830 and environment sensors 840 provide the ability to add game play variability to the track, further enhancing the user's experience.

In various embodiments, the game tracking function 1053 may keep track of points for actions performed by the user 110 controlling the RC device 180. For example, in various embodiments, art obstacle course may be set up within the environment 640 where the user may be required to locate certain objects. As the RC device 180 is controlled in the environment 640, the user 110 may be awarded points when the RC device 180 comes within the proximity of the valued object or when the RC device 180 is navigated through the proximity area. In various embodiments, during a race or combat style environment, a winner may be determined and awarded points, and based on previously awarded points, users 110 may have an advantage when accessing the system again. For example, in various embodiments, advanced points might enable a user 110 to select a more advanced RC device 180, play with a higher priority on the RC device 180 scheduling, or utilize exclusive environments 640.

In various embodiments, the achievement list 1054 may log specific environment data, including but not limited to highest speed, minimum course completion time, and other records which will be maintained as environment records. The records may be available for users to review and try to achieve the top records.

In various embodiments, the artificial intelligence function 1055 is con figured to allow the device server 620 to provide some level of functioning to the RC device. For example, in various embodiments, the device server 620 may be programmed to operate one or more of the RC devices 180 to provide an enhanced user experience. In various embodiments, for the novice user, the device server 620 can be programmed to assist the user, such as but not inclusive of: maintaining control over one of the RC device's 180 control surfaces while the user operates the other control surface (such as might be necessary to fly a helicopter) or limiting speed control until the user becomes familiar with the environment 640. In various embodiments, for other users, the device server 620 may act as an information source such as but not inclusive of alerting to dangers ahead, projecting current speed versus opponents speed, and other game play concepts. In some cases, it might be necessary for the device server 620 to assist the RC device 180. For example, in various embodiments, if the communication link delay between the user and the RC device 180 is too long, the device server 620 may determine that additional commands are needed to keep the RC device 180 operating safely.

In various embodiments, the device server 620 may also use AI 1055 to detect malicious intent. In various embodiments, the device server 620 may monitor the operation of all RC devices 180 and determine malicious intent of users. For example, in various embodiments, the device server 620 may monitor for a user who is controlling their RC device 180 to cause harm to other RC devices 180 or to the environment 640. In case of malicious intent, the AI 1055 may prevent the user from further operation.

In various embodiments, the AI 1055 may perform a network latency analysis to perform a latency check on each controller 150, 150′, 150″ connected to the gateway server 710 and update the user profile 934. In various embodiments, the gateway server 710 may perform artificial intelligence functions to compensate in case of poor transmissions or may force a user 110 with a poor latency to re-login and utilize a different environment 640, in various embodiments, the gateway server 710 may increase the latency of a controller 150 with a low latency so that all of the users are operating the RC devices 180, 180′ with the same latency.

Referring now to FIG. 11, the registration and RC device 180 selection process 1102 is shown. In various embodiments, during the registration and selection process 1102, the application 160 may communicate with the gateway server 710 over the network 610. The registration and selection process 1102 begins with activating the application 160 (1104). The activation may require the user 110 to press a physical button 318 or soft control 320 on the controller 150. If the user 110 is a new user 110 (1106) the user 110 must register to use the system (1108) and create a username and password. After registration, or, if user 110 is not a new user, the user 110 will be prompted to login to the system using a username and password (1110). The user 110 may use the physical buttons 318 such as a keyboard or keypad or soft controls 320 to input the username and password.

After the user 110 has entered their information, the user 110 may activate the login button 414. The login button 414 may consist of a physical button 318 or soft controls 320. After the user 110 completes the login activity, the application 160 may send the login data to the gateway server 710 (1112).

The gateway server 710 may confirm that the username and password match the records stored in the gateway server 710. If the information does not match, the gateway server 710 may require the user 110 to re-enter their username 402 and password 412 (1116).

Upon authentication, the gateway server 710 may send promotional data or additional information to the application 160 (1118). This information may then be displayed to the user 110 on the display 314 and the user 110 may confirm receipt of this information by pressing a soft control 320 or physical button 318 to continue (1120). The application 160 may then request an account status from the gateway server 710 (1122).

The account data may then be sent from the gateway server 710 to the application 160 (1124). The user 110 may then determine if adequate access time is available for their desired operation (1126). If the user 110 does not have adequate time, the user 110 may be given the option of buying more time (1128). If the user 110 does not want to purchase more time and has no time left, the user 110 may then return to the application profile (1130). If the user 110 desires to purchase more time, the user 110 may purchase more time (1132). Upon completion of the purchase, the account status may then be updated and displayed (1134). This information may be displayed until the user 110 presses continue on the controller 150. The application 160 may then requests that environment 640 or RC device 180 information be sent from the gateway server 710 (1136).

The user 110 may then begin the RC device 38/environment 640 selection process (1138). The gateway server 710 may send selection options to the application 160. The user 110 may then select a criteria (1140). The application 160 may send the selection to the gateway server 710 (1142). Steps 1138 through 1142 may be repeated several times based on the number of different types and levels of selection criteria available.

The gateway server 710 may determine which of RC devices 180 meet the selection criteria (1144) of the user 110. If no RC device 180 is available, the user 110 may be sent back in the selection process to where the RC devices 180 are available (1140).

The gateway server 710 may then send the RC device 180 and environment information to the application 160 (1148). The user 110 may then review the environment and/or device information via the application 160 (150) and determine whether to accept the environment 640 or the RC device 180 shown, or whether additional information or options is required (1152). If more information is required, the user 110 via the application 160 may requesting more information (1154) and the gateway server 710 may send the additional information (1156).

When the user 110 has decided to select the RC device 180, the user 110 may activate a soft control button 320 or physical button 318 on the controller 150 (1158). The application 160 may then send the selection to the gateway server 710 (1160). The gateway server 710 may then acknowledge the selection and hands the user 22/controller 150 application 160 over to device server 620 (1162).

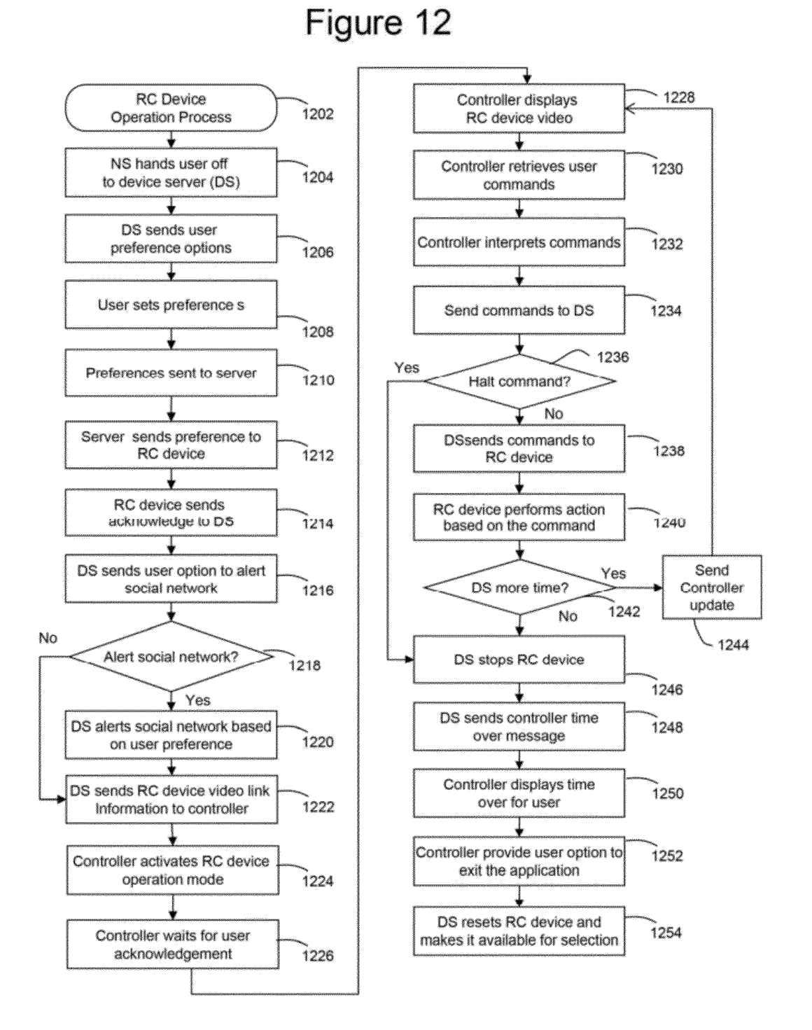

Referring now to FIG. 12, the RC device 180 operation process 1202 is performed using the controller 150 and application 160. During the operation process 1202, the application 160 is communicating with the device server 620 over the network 610.

After the gateway server 710 has handed off the controller 150 application 160 to the device server 620 (1204), the device server 620 may then send the application 160 the user 110 preference options (1206). The application 160 may use the display generation function 340 and the display 314 to show the user 110 the preference options (1206). The user 110 may use the physical buttons 318 and/or the soft controls 320 to select the preferences or adjust the option settings (1208). The application 160 may then perform command interpretation 342 on the user 110 inputs and then data is generated 334 and transmitted 312 to the device server 620 (1210). The device server 620 may then receive the data through the receive user profile 1012. The device server 620 may then determine if any data needs to be sent to the RC device 180, format the data, and send the user 110 profile to the RC device (1212). The transmission of the data may be performed over the RC network 170.

The RC device 180 may receive the data through its antenna 224 and wireless communication link 222. The programmable controller 220 may then act upon the data and send an acknowledgement back to the device server 620 (1214).

The application 160 may present the user 110 with an option for the user 110 to alert their social network regarding them logging onto the system (1218). The user 110 may be allowed to decide who should be alerted and the user 110 enters their decision using the physical buttons 318 or soft controls 320 on the controller 150. If the user 110 decides to alert their social network, the device server 620 may send out alerts to the user's 110 social network (1220).

The device server 620 may then send a video link information to the application 160 (1222). The application 160 may then activate the RC device 38(1224). The application 160 may wait for the user 110 to acknowledge that they are ready to operate the RC device 180 (1226).

Steps 1228 through 1244 may operate as a continuous loop which is performed while the user 110 is operating the RC device 180. The application 160 may display the RC device 180 video on the display 314 (1228). The application 160 may detect the user's 110 commands from the physical buttons 318, soft controls 320, and motion sensors 322 of the controller 150 (1230). The application 160 may take these commands and perform the command interpretation function 342 (1232). The application 160 may send the commands to the device server 620 (1234). The device server 620 may check for a halt command (1236). If a halt command has not been issued by the user 110, the device server 620 may format the user's 110 commands and send them to the RC device 180 through the RC network 170 (1238).

The RC device 180 may perform an action based on the command received (1240). While the RC device 180 performs the action, the device server 620 may confirm that the user 110 has more time (1242) and continues to send video to the controller 150 (1244).

As stated above, steps 1228 through 1244 may run in a continuous loop in real time as the user 110 continues to control the RC device 180. When the user 110 issues a halt command (1238) or runs out of access time (1242), the device server 620 stops the RC device 180 (1.246) and the device server 620 sends the application 160 a time over signal (1248). The application 160 may then display that the time is over to the user 110 on the display 314 (1250). The application 160 may then provide the user 110 the option to exit the application 160 or return to the RC device selection process 340 (1252). The device server 620 may then reset the RC device 180 and make it available for selection again (1254).

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages, and solutions to problems have been described above with regard, to particular embodiments. Any benefit, advantage, solution to problems, or any element that may cause any particular benefit, advantage, or solution to occur or to become more pronounced, however, is not to be construed as a critical, required, or essential feature or component.

The terms “comprises”, “comprising”, or any variation thereof are intended to reference a non-exclusive inclusion, such that a process, method, article, composition, or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A system for operating a remote controlled device, comprising:
a device server; and
a first controller configured to connect to the device server, wherein the remote controlled device is configured to receive at least one command from the first controller via the device server.

2. The system of claim 1, wherein the first controller comprises a smart phone.

3. The system of claim 1, wherein the first controller is configured to connect to the device server via a wireless network.

4. The system of claim 1, wherein the first controller comprises an motion sensor, wherein the first controller determines a command based on measurement from the motion sensor.

5. The system of claim 1, further comprising a first camera configured to provide a first video to the server, wherein the device server is further configured to stream the first video to the controller.

6. The system of claim 5, further comprising a second camera configured to provide a second video to the device server, wherein the device server is further configured to stream at least one of the first video and the second video to the first controller.

7. The system of claim 6, wherein the controller is further configured allow a user to select at least one of the first video and the second video.

8. The system of claim 5, wherein the server is configured to stream the first video to a network of viewers.

9. The system of claim 1, further comprising:
a second remote controlled device; and
a second controller configured to connect to the server, wherein the second remote controlled device is configured to receive at least one command from the second controller via the server.

10. The system of claim 9, wherein the server is configured to:
measure a first latency of the first controller and a second latency of the second controller;
compare the first latency with the second latency; and
adjust the latency of at least one of the first controller and second controller.

11. The system of claim 1, wherein the remote controlled device comprises a programmable controller, wherein the programmable controller is configured to receive the at least one command from the first controller and translate the at least one command into an action.

12. The system of claim 1, wherein the remote controlled device further comprises a wireless communication link configured to receive the at least one command and provide a message to the controller via the server.

13. The system of claim 1, wherein the remote controlled device further comprises a video camera and the message comprises video captured by the camera.

14. The system of claim 1, wherein the server is configured to store a user profile.

15. The system of claim 14, wherein the programmable controller is configured to receive the user profile from the server and operates according to the user profile.

16. The system of claim 12, wherein the remote controlled device further comprises a sensor configured to sense a proximity to a hotspot and provide feedback according to the proximity to the hotspot.

17. The system of claim 1, wherein the device server is configured to control at least one physical feature and one electronic feature.

18. The system of claim 17, wherein the server is configured to track the location of the first remote controlled device and at least one of:
modify, the command from the user according to the location of the first remote controlled device;
control at least one of a physical and an electronic feature; and
operate normally.

19. The system of claim 1, further comprising a second remote controlled device, wherein the server is configured to control a second remote controlled device using artificial intelligence.

20. The system of claim 1, wherein the server is configured to utilize artificial intelligence to supplement a command from the first controller.

21. A method of operating a remote controlled device, comprising:
inputting a command into a first controller;
transmitting the command to a server;
relaying the command from the server to control a first remote controlled device; and
receiving on the first controller, a first feedback from the first remote controlled device via the server and a supplementary feedback from the server.

22. The method of claim 21, wherein transmitting the command to the server comprises transmitting the command via a wireless network.

23. The method of claim 21, wherein inputting the command into the first controller comprises measuring a movement of the first controller.

24. The method of claim 21, further comprising:
inputting a second command into a second controller;
transmitting the second command to the server;
relaying the command from the server to control a second remote controlled device located in the facility; and
receiving on the controller, a third feedback from the second remote controlled device via the server and a second supplementary feedback from the server

25. The method of claim 24, further comprising recording a first video, wherein the first feedback comprises the first video.

26. The method of claim 25, further comprising recording a second video, wherein the first feedback comprises at least one of the first video and the second video to the controller from the server.

27. The method of claim 26, wherein the first feedback comprises the first video and the third feedback comprises the second video.

28. The method of claim 24, further comprising streaming from the server at least one of the first video and the second video to a network of viewers.

29. The method of claim of claim 24, further comprising:
measuring a first latency of the first controller and a second latency of the second controller;
comparing the first latency with the second latency; and
adjusting the latency of at least one of the first controller and second controller.

30. The method of claim 21, further comprising selecting the first remote controlled device from a plurality of remote controlled devices by the server.

31. The method of claim 21, further comprising uploading a user profile to the server.

32. The method of claim 31, wherein relaying the command from the server to control a first remote controlled device comprises:
adjusting the command according to the user profile; and
relaying the adjusted command to the first remote controlled device.

33. The method of claim 21, further comprising:
detecting the proximity of the first remote controlled device to a hotspot; and
adjusting the second feedback according to the proximity to the hotspot.

34. The method of claim 21, further comprising:
detecting the proximity of the first remote controlled device to a feature; and
triggering at least one of a physical feature and an electronic feature according to the proximity to the feature by the server.

35. The method of claim 21, further comprising tracking the location of the remote controlled device by the server.

36. The method of claim 21, further comprising controlling a second remote control device by artificial intelligence running on the server.

37. The method of claim 21, wherein relaying the command from the server to control the first remote controlled device comprises:
analyzing the command using artificial intelligence on the server;
adjusting the command; and
relaying the adjusted command to the first remote controlled device.

38. A system for operating a first remote controlled device, comprising:
a server configured to control the first remote controlled device;
a camera configured to provide a first video to the server;
a first controller configured to:
receive a command from a user;
relay the command to the server; and
receive the first video and a feedback from the server.

39. The system of claim 38, wherein the first controller comprises a programmable phone.

40. The system of claim 38, wherein the first controller further comprises an motion sensor,
wherein the first controller the command from the users comprises a command based on a measurement from the motion sensor.

41. The system of claim 38, further comprising a second camera configured to provide a second video to the server, wherein the server is further configured to stream at least one of the first video and the second video to the controller.

42. The system of claim 41, wherein the controller is further configured allow the user to select at least one of the first video and the second video.

43. The system of claim 42, wherein the server is configured to stream at least one of the first video and the second video to a network of viewers.

44. The system of claim 38, wherein the feedback comprises at least one of a sound, a graphic, and a message.

45. The system of claim 38, further comprising:
a second remote controlled device; and
a second controller configured to:
receive a second command from a second user;
relay the second command to the server; and
receive the first video and a second feedback from the server.

46. The system of claim 44, wherein the server is configured to:
measure a first latency of the first controller and a second latency of the second controller;
compare the first latency with the second latency; and
adjust the latency of at least one of the first controller and second controller.

47. The system of claim 38, wherein the remote controlled device comprises a programmable controller, wherein the programmable controller is configured to receive the at least one command from the first controller and translate the at least one command into an action.

48. The system of claim 47, wherein the remote controlled device further comprises a wireless communication link configured to receive the at least one command and provide a message to the controller via the server.

49. The system of claim 48, wherein the remote controlled device further comprises a video camera and the message comprises video captured by the camera.

50. The system of claim 38, wherein the server is configured to store a user profile.

51. The system of claim 50, wherein the programmable controller is configured to receive user profile from the server and operates according to the user profile.

52. The system of claim 48, wherein the programmable controller is configured to sense a proximity to a hotspot and the message comprises the proximity to the hotspot.

53. The system of claim 38, wherein the server is configured to control at least one physical feature and one electronic feature.

54. The system of claim 53, wherein the server is configured to track the location of the first remote controlled device and at least one of:
modify the command from the user according to the location of the first remote controlled device;
control at least one of a physical and an electronic feature; and
operate normally.

55. The system of claim 38, wherein the server is configured to control a second remote controlled device using artificial intelligence.

56. The system of claim 38, wherein the server is configured to utilize artificial intelligence to supplement a command from the first controller.

57. The system of claim 38, further comprising a third controller wherein the third controller is configured to control the first remote controlled device in conjunction with the first controller.

58. The system of claim 38, wherein the server is configured to:
detect a battery level of the remote controlled device; and
direct the RC device to a charging station.
